(19) United States
(12) Patent Application Publication
(10) Pub. No.: US 2019/0278286 A1
(43) Pub. Date: Sep. 12, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Yugo Ueda, Wako-shi (JP)

(21) Appl. No.: 16/292,398

(22) Filed: Mar. 5, 2019

(30) Foreign Application Priority Data
Mar. 9, 2018 (JP) 2018-043588

(51) Int. Cl. G05D 1/02; G06K 9/00; G05D 1/00

(52) U.S. Cl. CPC G05D 1/0223; G06K 9/00791; G05D 1/0246; G05D 1/0257; G05D 1/0088

(57) ABSTRACT

A vehicle control device (100) includes a recognition unit (132) including an acquisition unit (134) that is configured to acquire information on a traffic management state of signals on a route of a vehicle, the recognition unit being configured to recognize a situation of the surroundings of the vehicle, and a driving control unit (142, 160) that is configured to control acceleration, deceleration, and steering of the vehicle on the basis of the situation of the surroundings of the vehicle recognized by the recognition unit, and in a case that a route along which the vehicle is able to arrive at a destination is able to be set irrespective of which of directions of progression of the vehicle is selected at an intersection at which a signal is provided, the driving control unit is configured to determine a route to the destination on the basis of information acquired by the acquisition unit to cause the vehicle to travel.

### CROSS-REFERENCE TO RELATED APPLICATION

Priority is claimed on Japanese Patent Application No. 2018-043588, filed Mar. 9, 2018, the content of which is incorporated herein by reference.

### BACKGROUND

### Field of the Invention

The present invention relates to a vehicle control device, a vehicle control method, and a storage medium.

### Description of Related Art

In recent years, research on automatic vehicle control has progressed. In relation thereto, a technology for performing guidance on a route to a destination by detouring around a congested place according to road conditions is known (see, for example, Japanese Unexamined Patent Application, First Publication No. 2001-349735). In the technology according to Patent Document 1, the road conditions are acquired through communication, and a current route and a detour route for avoiding congestion are guided to a user, who is prompted to select one of the routes.

### SUMMARY

However, in the related art, the route is not determined in consideration of content of displays of signals provided on the route. Therefore, the time required to reach a destination is likely to long due to the influence of signals provided on the determined route.

The present invention has been made in consideration of such circumstances, and an object of the present invention is to provide a vehicle control device, a vehicle control method, and a storage medium with which an efficient route to a destination is able to be determined.

A vehicle control device, a vehicle control method, and a storage medium according to the present invention adopt the following configurations.

(1): A vehicle control device according to an aspect of the present invention is a vehicle control device including: a recognition unit including an acquisition unit that is configured to acquire information on a traffic management state of signals on a route of a vehicle, the recognition unit being configured to recognize a situation of the surroundings of the vehicle; and a driving control unit that is configured to control acceleration, deceleration, and steering of the vehicle on the basis of the situation of the surroundings of the vehicle recognized by the recognition unit, wherein in a case that a route along which the vehicle is able to arrive at a destination is able to be set irrespective of which of directions of progression of the vehicle is selected at an intersection at which a signal is provided, the driving control unit causes the vehicle to travel by determining a route to the destination on the basis of information acquired by the acquisition unit.

(2): In the aspect (1), the acquisition unit is configured to recognize the traffic management state of the signal at a point in time of acquisition of the information and/or predicts the traffic management state of the signal at a future point in time.

(3): In the aspect (2), the driving control unit is configured to give priority to causing the vehicle to progress straight to set the route in a case that the traffic management state of the signal at the time of acquisition of the information is a state in which the vehicle is able to travel straight ahead, and give priority to causing the vehicle to progress in either one of directions of turning right and turning left to set the route in a case that the traffic control state of the signal is a state in which the vehicle is unable to travel straight ahead and able to progress in either one of directions of turning right and turning left.

(4): In the aspect (1), the driving control unit is configured to compare the routes to the destination that are able to be selected with each other, and determine the route to the destination according to the traffic management state of the signal in a case that a difference between required times to the destination is within a predetermined time, or in a case that a difference between distances to the destination is within a predetermined range.

(5) In the aspect (1), the driving control unit is configured to determine the route to the destination on the basis of a switching time of the traffic control state of the signal.

(6): In the aspect (1), the driving control unit is configured to compare the routes to the destination that are able to be selected with each other on the basis of the information acquired by the acquisition unit, and set the route to the destination so that the number of signals before the destination is reduced.

(7): In the aspect (1), the driving control unit is configured to set a route to the destination in which the vehicle progresses in a direction of an arrow display in a case that the driving control unit determines that the vehicle is able to progress to a road corresponding to the arrow display within the display time of the arrow display displayed by the signal.

(8): In the aspect (1), the driving control unit is configured to select a lane in which the number of times of lane change is reduced according to a traffic management state of the signal among a plurality of lanes provided in the progression direction of the vehicle before the vehicle passes through an intersection corresponding to the signal.

(9): A vehicle control method according to an aspect of the present invention is a vehicle control method using an in-vehicle computer, including: acquiring, by a vehicle control device, information on a traffic management state of a signal on a route of a vehicle; recognizing, by the vehicle control device, a situation of surroundings of the vehicle; controlling, by the vehicle control device, acceleration, deceleration, and steering of the vehicle on the basis of the recognized situation of the surroundings of the vehicle; and determining, by the vehicle control device, a route to the destination on the basis of the acquired information and causing the vehicle to travel in a case that a route along which the vehicle is able to arrive at the destination is able to be set irrespective of which of directions of progression of the vehicle is selected at an intersection at which a signal is provided.

(10): A storage medium according to an aspect of the present invention is a computer-readable non-transient storage medium storing a program, the program being configured to cause a vehicle control device to: acquire information on a traffic management state of a signal on a route of a vehicle; recognize a situation of surroundings of the vehicle; control acceleration, deceleration, and steering of the vehicle on the basis of the recognized situation of the surroundings of the vehicle; and determine a route to the destination on the basis of the acquired information and cause the vehicle to travel in a case that a route along which the vehicle is able to arrive at the destination is able to be set irrespective of which of directions of progression of the vehicle is selected at an intersection at which a signal is provided.

According to the aspects (1) to (10), it is possible to determine an efficient route to the destination.

According to the aspects (2), (3), (5), and (7), it is also possible to determine an efficient route according to content of displays of signals.

According to the aspect (8), it is also possible to change a lane efficiently at intersections.

### BRIEF DESCRIPTION OF THE DRAWINGS

FIG. 1 is a configuration diagram of a vehicle system 1 using a vehicle control device according to an embodiment.

FIG. 2 is a functional configuration diagram of a first control unit 120 and a second control unit 160.

FIG. 3 is a diagram showing an example of a settable route to a destination.

FIG. 4 is a diagram showing an example of content of management information G of a signal S.

FIG. 5 is a diagram showing an intersection at which a subject vehicle M turns right.

FIG. 6 is a diagram showing another example of roads on which signals are provided.

FIG. 7 is a diagram showing another example of roads on which signals are provided.

FIG. 8 is a flowchart showing an example of a short-term flow of a process that is executed in the automated driving control device 100.

FIG. 9 is a flowchart showing an example of a flow of process of determining a long-term route that is executed in the automated driving control device 100.

FIG. 10 is a diagram showing an example of a hardware configuration of an automated driving control device 100 according to an embodiment.

### DETAILED DESCRIPTION OF THE INVENTION

Hereinafter, embodiments of a vehicle control device, a vehicle control method, and a storage medium according to the present invention will be described with reference to the drawings. Hereinafter, a case in which left-hand driving is applied will be described, but the right and the left may be reversed in a case that right-hand driving is applied.

[Overall Configuration]

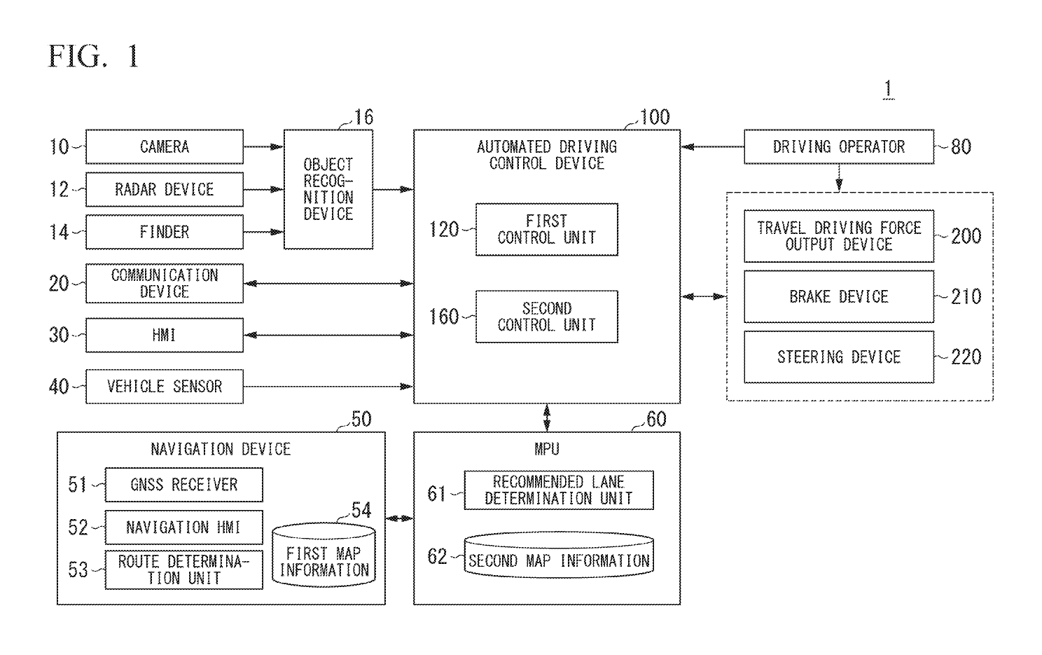

FIG. 1 is a configuration diagram of a vehicle system 1 using a vehicle control device according to an embodiment. A vehicle in which the vehicle system 1 is mounted is, for example, a vehicle such as a two-wheeled vehicle, a three-wheeled vehicle, or a four-wheeled vehicle. A driving source thereof is an internal combustion engine such as a diesel engine or a gasoline engine, an electric motor, or a combination thereof. The electric motor operates using power generated by a power generator connected to the internal combustion engine, or discharge power of a secondary battery or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a travel driving force output device 200, a brake device 210, and a steering device 220. These units or devices are connected to each other by a multiplex communication line such as a controller area network (CAN) communication line, a serial communication line, a wireless communication network, or the like. The configuration shown in FIG. 1 is merely an example, and a part of the configuration may be omitted or still another configuration may be added.

The camera 10 is, for example, a digital camera using a solid-state imaging device such as a charge coupled device (CCD) or a complementary metal oxide semiconductor (CMOS). The camera 10 is attached to any place on the vehicle in which the vehicle system 1 is mounted (hereinafter referred to as a subject vehicle M). In the case of forward imaging, the camera 10 is attached to an upper portion of a front windshield, a rear surface of a rearview mirror, or the like. The camera 10, for example, periodically repeatedly images the periphery of the subject vehicle M. The camera 10 may be a stereo camera.

The radar device 12 radiates radio waves such as millimeter waves to the surroundings of the subject vehicle M and detects radio waves (reflected waves) reflected by an object to detect at least a position (a distance and orientation) of the object. The radar device 12 is attached to any place on the subject vehicle M. The radar device 12 may detect a position and a speed of the object using a frequency modulated continuous wave (FM-CW) scheme.

The finder 14 is a light detection and ranging (LIDAR). The finder 14 radiates light to the vicinity of the subject vehicle M and measures scattered light. The finder 14 detects a distance to a target on the basis of a time from light emission to light reception. The radiated light is, for example, pulsed laser light. The finder 14 is attached to any place on the subject vehicle M. The finder 14 is attached to any place on the subject vehicle M.

The object recognition device 16 performs a sensor fusion process on detection results of some or all of the camera 10, the radar device 12, and the finder 14 to recognize a position, type, speed, and the like of the object. The object recognition device 16 outputs recognition results to the automated driving control device 100. The object recognition device 16 may output the detection results of the camera 10, the radar device 12, or the finder 14 to the automated driving control device 100 as they are. The object recognition device 16 may be omitted from the vehicle system 1.

The communication device 20, for example, communicates with another vehicle that is present around the subject vehicle M using a cellular network, a Wi-Fi network, Bluetooth (registered trademark), dedicated short range communication (DSRC), or the like or communicates with various server devices via a wireless base station.

The HMI 30 presents various types of information to an occupant of the subject vehicle M and receives an input operation from the occupant. The HMI 30 includes various display devices, speakers, buzzers, touch panels, switches, keys, and the like.

The vehicle sensor 40 includes, for example, a vehicle speed sensor that detects a speed of the subject vehicle M, an acceleration sensor that detects an acceleration, a yaw rate sensor that detects an angular speed around a vertical axis, and an orientation sensor that detects a direction of the subject vehicle M.

The navigation device 50 includes, for example, a global navigation satellite system (GNSS) receiver 51, a navigation HMI 52, and a route determination unit 53. The navigation device 50 holds first map information 54 in a storage device such as a hard disk drive (HDD) or a flash memory. The GNSS receiver 51 specifies a position of the subject vehicle M on the basis of a signal received from a GNSS satellite. The position of the subject vehicle M may be specified or supplemented by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. The route determination unit 53, for example, determines a route (hereinafter, an on-map route) from the position of the subject vehicle M (or any input position) specified by the GNSS receiver 51 to a destination input by the occupant using the navigation HMI 52 by referring to the first map information 54. The first map information 54 is, for example, information in which a road shape is represented by links indicating roads and nodes connected by the links. The first map information 54 may include a curvature of the road, point of interest (POI) information, and the like. The on-map route is output to the MPU 60. The navigation device 50 may perform route guidance using the navigation HMI 52 on the basis of the on-map route. The navigation device 50 may be realized, for example, by a function of a terminal device such as a smartphone or a tablet terminal possessed by the occupant. The navigation device 50 may transmit a current position and a destination to a navigation server via the communication device 20 and acquire the same route as the on-map route from the navigation server.

The MPU 60 includes, for example, a recommended lane determination unit 61, and holds second map information 62 in a storage device such as an HDD or a flash memory. The recommended lane determination unit 61 divides the on-map route provided from the navigation device 50 into a plurality of blocks (for example, divides the route every 100 [m] in a progression direction of the vehicle), and determines a recommended lane for each block by referring to the second map information 62. The recommended lane determination unit 61 determines in which lane from the left the subject vehicle M travels. The recommended lane determination unit 61 determines the recommended lane so that the subject vehicle M can travel on a reasonable route for progression to a branch destination in a case that there is a branch place in the on-map route.

The second map information 62 is map information with higher accuracy than the first map information 54. The second map information 62 includes, for example, information on a center of the lane or information on a boundary of the lane, and information on a position of the intersection. The second map information 62 may include road information, traffic regulation information, address information (an address and postal code), facility information, telephone number information, identification information of signals, and the like. The second map information 62 may be updated at any time by the communication device 20 communicating with another device.

The driving operator 80 includes, for example, an accelerator pedal, a brake pedal, a shift lever, a steering wheel, a variant steer, a joystick, and other operators. A sensor that detects the amount of operation or the presence or absence of operation is attached to the driving operator 80, and a detection result is output to the automated driving control device 100 or some or all of the travel driving force output device 200, the brake device 210, and the steering device 220.

The automated driving control device 100 (a vehicle control device) includes, for example, a first control unit 120, and a second control unit 160. The first control unit 120 and the second control unit 160 are realized, for example, by a hardware processor such as a central processing unit (CPU) executing a program (software). Some or all of these components may be realized by hardware (including circuitry) such as a large scale integration (LSI), an application specific integrated circuit (ASIC), a field-programmable gate array (FPGA), or a graphics processing unit (GPU) or may be realized by software and hardware in cooperation. The program may be stored in a storage device such as an HDD or a flash memory of the automated driving control device 100 in advance or may be stored in a removable storage medium such as a DVD or a CD-ROM and the storage medium may be mounted in a drive device so that the program may be installed in the HDD or the flash memory of the automated driving control device 100.

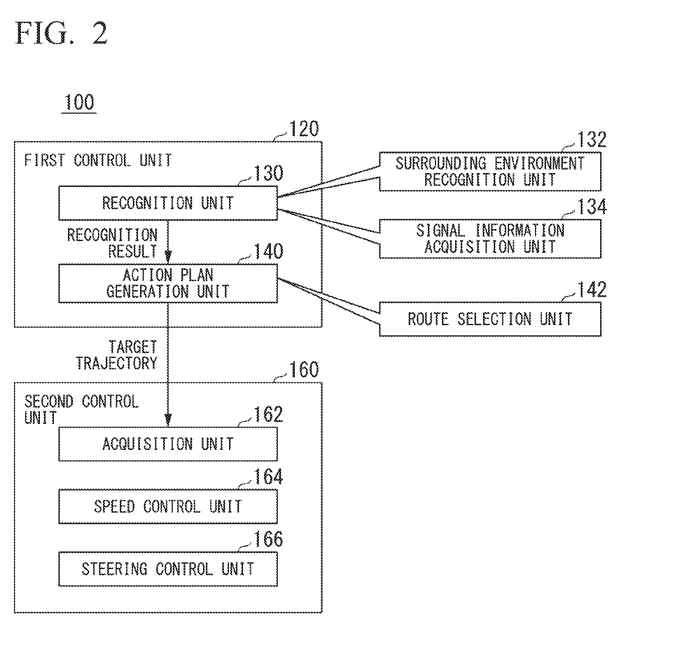

FIG. 2 is a functional configuration diagram of the first control unit 120, and the second control unit 160. The first control unit 120 includes, for example, a recognition unit 130 and an action plan generation unit 140. The first control unit 120 realizes, for example, a function on the basis of artificial intelligence (AI) and a function on the basis of a previously given model in parallel. For example, in a function of “recognizing an intersection,” recognition of the intersection using deep learning or the like and recognition on the basis of previously given conditions (a signal which can be subjected to pattern matching, a road sign, or the like) are executed in parallel, and the function of recognizing an intersection is realized by scoring both recognitions and comprehensively evaluating the recognitions. Accordingly, the reliability of automated driving is guaranteed.

The recognition unit 130 recognizes a state such as a position, speed or acceleration of an object near the subject vehicle M on the basis of information input from the camera 10, the radar device 12, and the finder 14 via the object recognition device 16. The position of the object, for example, is recognized as a position at absolute coordinates with a representative point (a centroid, a drive shaft center, or the like) of the subject vehicle M as an origin, and is used for control. The position of the object may be represented by a representative point such as a centroid or a corner of the object or may be represented by a represented area. The “state” of the object may include an acceleration or jerk of the object, or an “action state” (for example, whether or not the object is changing lanes or is about to change lanes).

The recognition unit 130 includes a surrounding environment recognition unit 132 and a signal information acquisition unit 134. The surrounding environment recognition unit 132 recognizes a surrounding environment of the subject vehicle M. The signal information acquisition unit 134 acquires information from the signal and determines content of current and future displays of the signal on the route on which the subject vehicle M travels. Content of processes of the surrounding environment recognition unit 132 and the signal information acquisition unit 134 will be described below.

In principle, the action plan generation unit 140 generates a target trajectory along which the subject vehicle M will travel in the future automatically (without depending on an operation of a driver) so that the subject vehicle M can generally travel on the recommended lane determined by the recommended lane determination unit 61 and cope with a surrounding situation of the subject vehicle M. The target trajectory includes, for example, a speed element. For example, the target trajectory is represented as a sequence of points (trajectory points) at which the subject vehicle M is to arrive. The trajectory point is a point at which the subject vehicle M is to arrive for each predetermined travel distance (for example, several meters) at a road distance, and a target speed and a target acceleration at every predetermined sampling time (for example, several tenths of a [sec]) are separately generated as part of the target trajectory. The trajectory point may be a position at which the subject vehicle M is to arrive at the sampling time at every predetermined sampling time. In this case, information on the target speed or the target acceleration is represented by the interval between the trajectory points.

In a case that the action plan generation unit 140 generates the target trajectory, the action plan generation unit 140 may set an event of automated driving. Examples of the automated driving event include a constant speed traveling event, a low speed following driving event, a lane changing event, a branching event, a merging event, and a takeover event. The action plan generation unit 140 generates a target trajectory according to an activated event.

The action plan generation unit 140 includes a route selection unit 142. The route selection unit 142 determines a route to the destination according to the content of the display of the signal on the basis of a determination result of the signal information acquisition unit 134. The content of a process of the route selection unit 142 will be described below.

The second control unit 160 controls the travel driving force output device 200, the brake device 210, and the steering device 220 so that the subject vehicle M passes through the target trajectory generated by the action plan generation unit 140 at a scheduled time. A combination of the route selection unit 142 and the second control unit 160 is an example of the driving control unit.

The second control unit 160 includes, for example, an acquisition unit 162, a speed control unit 164, and a steering control unit 166. The acquisition unit 162 acquires information on the target trajectory (trajectory points) generated by the action plan generation unit 140 and stores the information on the target trajectory in a memory (not shown). The speed control unit 164 controls the travel driving force output device 200 or the brake device 210 on the basis of the speed element incidental to the target trajectory stored in the memory. The steering control unit 166 controls the steering device 220 according to a degree of bend of the target trajectory stored in the memory. Processes of the speed control unit 164 and the steering control unit 166 are realized by, for example, a combination of feedforward control and feedback control. For example, the steering control unit 166 executes a combination of feedforward control according to a curvature of a road in front of the subject vehicle M and feedback control on the basis of a deviation from the target trajectory.

The travel driving force output device 200 outputs a travel driving force (torque) for traveling of the vehicle to the driving wheels. The travel driving force output device 200 includes, for example, a combination of an internal combustion engine, an electric motor, a transmission, and the like, and an ECU that controls these. The ECU controls the above configuration according to information input from the second control unit 160 or information input from the driving operator 80.

The brake device 210 includes, for example, a brake caliper, a cylinder that transfers hydraulic pressure to the brake caliper, an electric motor that causes the cylinder to generate hydraulic pressure, and a brake ECU. The brake ECU controls the electric motor according to information input from the second control unit 160 or information input from the driving operator 80 so that a brake torque according to a braking operation is output to each wheel. The brake device 210 may include a mechanism that transfers the hydraulic pressure generated by the operation of the brake pedal included in the driving operator 80 to the cylinder via a master cylinder as a backup. The brake device 210 is not limited to the configuration described above and may be an electronically controlled hydraulic brake device that controls the actuator according to information input from the second control unit 160 and transfers the hydraulic pressure of the master cylinder to the cylinder.

The steering device 220 includes, for example, a steering ECU and an electric motor. The electric motor, for example, changes a direction of the steerable wheels by causing a force to act on a rack and pinion mechanism. The steering ECU drives the electric motor according to information input from the second control unit 160 or information input from the driving operator 80 to change the direction of the steerable wheels.

[Method of Determining Route in Road on which Signal is Provided]

Hereinafter, an example of a process of determining the route to the destination of the subject vehicle M executed by the action plan generation unit 140 will be described. In principle, the action plan generation unit 140 causes the subject vehicle M to travel along the recommended route determined by the MPU 60, but reexamines an efficient route again in consideration of the presence of a signal or an influence of a traffic management state of the signal to be described below at a place at which there is the signal. The following functions may be included in the MPU 60.

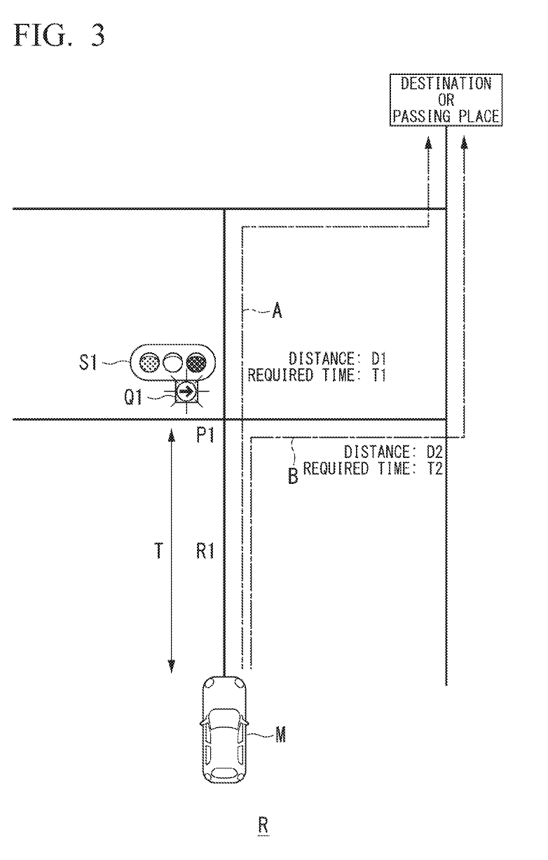

FIG. 3 is a diagram showing an example of a settable route to a destination. As shown in FIG. 3, for example, in a case that there are a plurality of routes having the same distance to the destination, the number of signals S or content of the displays are different in respective routes A and B. Then, even in a case that the distances to the destination are the same, required times may be different according to the selected route.

In a case that the plurality routes to the destination can be set, the action plan generation unit 140 determines a route along which the subject vehicle M can efficiently arrive at the destination according to the content of the displays of the signal recognized by the signal information acquisition unit 134. The action plan generation unit 140 causes the subject vehicle M to travel on the lane recognized by the surrounding environment recognition unit 132 in the determined route. Hereinafter, a process of determining a route to the destination of the subject vehicle M, which is executed by the action plan generation unit 140, will be described.

[Function of Surrounding Environment Recognition Unit]

The surrounding environment recognition unit 132 recognizes a surrounding environment of the subject vehicle M. The surrounding environment recognition unit 132 analyzes an image acquired by the camera 10 on the basis of a difference in luminance and recognizes the surrounding environment of the subject vehicle M. The surrounding environment recognition unit 132 recognizes a traveling road boundary (a road boundary) including a road marking line, a road shoulder, a curb stone, a median strip, a guard rail, and the like to recognize a traveling lane.

For example, the surrounding environment recognition unit 132 compares a pattern of a road marking line (for example, an arrangement of a solid line and a broken line) obtained from the second map information 62 with a pattern of a road marking line around the subject vehicle M recognized from the image captured by the camera 10 to recognize the traveling lane. In this recognition, a position of the subject vehicle M acquired from the navigation device 50 or a processing result of an INS may be added.

The surrounding environment recognition unit 132 may recognize a temporary stop line, obstacles, a toll gate, and other road events. The surrounding environment recognition unit 132 recognizes the traveling lane in which the subject vehicle M is traveling on the basis of the recognized traveling lane.

The surrounding environment recognition unit 132 recognizes a position or a posture of the subject vehicle M relative to the traveling lane in a case that recognizing the traveling lane in which the subject vehicle M is traveling. The surrounding environment recognition unit 132 may recognize, for example, a deviation of a reference point of the subject vehicle M from a center of the lane, and an angle formed between a progression direction of the subject vehicle M and a line connecting a center of the lane as a relative position and a posture of the subject vehicle M with respect to the traveling lane. Instead, the surrounding environment recognition unit 132 may recognize, for example, a position of the reference point of the subject vehicle M with respect to any one of side end portions (the road marking line or the road boundary) of the traveling lane as the relative position of the subject vehicle M with respect to the traveling lane.

The surrounding environment recognition unit 132, for example, recognizes a lane in which the subject vehicle M can progress, such as a straight lane, a left turn lane, and a right turn lane at the intersection. The surrounding environment recognition unit 132 recognizes a direction in which the subject vehicle M can progress, such as straight traveling, a left turn, and a right turn in travel classification of the lane in which the subject vehicle M travels, on the basis of the pattern of the road marking lines obtained from the second map information 62 and the image analysis of the camera 10.

The surrounding environment recognition unit 132 may recognize a road environment around the subject vehicle M by referring to the second map information 62 or may complement information that cannot be acquired by the camera 10 by referring to the second map information 62.

[Function of Signal Information Acquisition Unit]

The signal indicates a traffic management state to nearby vehicles by switching a display color or the presence or absence of a display using the display device. The traffic control state is a state indicating whether or not passage is permitted in either direction. It is assumed that the signal indicates the traffic management state to nearby vehicles using a notification means such as color, communication, or sound.

The signal information acquisition unit 134 acquires information on the traffic management state of the signal. The signal information acquisition unit 134, for example, recognizes content of a display of a signal S of the subject vehicle M on the basis of a luminance, color, or the like of the image recognized by the camera 10 and acquires the traffic management state of the signal S.

In addition to the recognition result of the camera 10, the signal information acquisition unit 134 may communicate with the signal S via the communication device 20 to acquire the traffic management state of the signal S, or may communicate with a communication device installed on a road or another vehicle to acquire traffic management information of the signal S. The signal information acquisition unit 134 may complement information that cannot be acquired by the camera 10, by referring to the second map information 62. For example, the signal information acquisition unit 134 may acquire a route on which the subject vehicle M may travel or a signal ID of the signal S1 on a route on which the subject vehicle M travels by referring to the second map information 62 in advance and calculate the number of signals S1.

First, a case in which the camera 10 recognizes the traffic management state represented by the content of the display of the signal S will be described. The signal information acquisition unit 134, for example, acquires the image recognized by the camera 10 at predetermined sampling intervals and analyzes the color of the acquired image to recognize the content of the display of the signal.

The content of the display of the signal S is, for example, the presence or absence or a blinking state of a display (lighting) for each display color of the signal, and the presence or absence of a progression direction such as an arrow. The signal information acquisition unit 134 may compare a plurality of images recognized by the camera 10 with each other at predetermined time intervals, extract a time for which the display color is displayed and a time for which the display color is not displayed, and recognize whether or not the display of the signal S is blinking.

In a case that the display color of the signal S is blue, the signal information acquisition unit 134 recognizes that the vehicle can travel straight ahead. In a case that the signal S displays an arrow display, the signal information acquisition unit 134 recognizes that the subject vehicle M can progress in a progression direction of the road associated with the arrow. The signal information acquisition unit 134 determines that the subject vehicle M will stop in a case that the display color of the signal S is red, determines that the subject vehicle M will travel slowly in a case that the display color of the signal S blinks yellow, and recognizes that the subject vehicle M will temporarily stop in a case that the display color of the signal S blinks red.

Next, a case in which the traffic management state of the signal S is acquired through communication will be described. The signal information acquisition unit 134 acquires management information on the traffic management state of the signal S from the signal S on the route or near the route of the subject vehicle M via the communication device 20. The signal information acquisition unit 134 refers to the navigation device 50 and the second map information 62.

The signal information acquisition unit 134 acquires information on the position of the subject vehicle M, links of the road on which the subject vehicle M is traveling, and nodes of the roads in the progression direction, communicates with the signal corresponding to the link of the road on which the subject vehicle M is traveling at an intersection at which the subject vehicle M arrives on the basis of the information, and acquires information on the traffic management state. In the example of FIG. 3, the signal information acquisition unit 134 communicates with the signal 51 of the intersection P1 corresponding to the link R1 of the road on which the subject vehicle M travels.

The signal information acquisition unit 134 acquires the signal ID of the signal S1 in advance by referring to the second map information 62, designates the signal S1 corresponding to the link of the road on which the subject vehicle M is traveling as a destination, and performs inquiry. The signal information acquisition unit 134 acquires management information from the signal of which the inquiry has been performed.

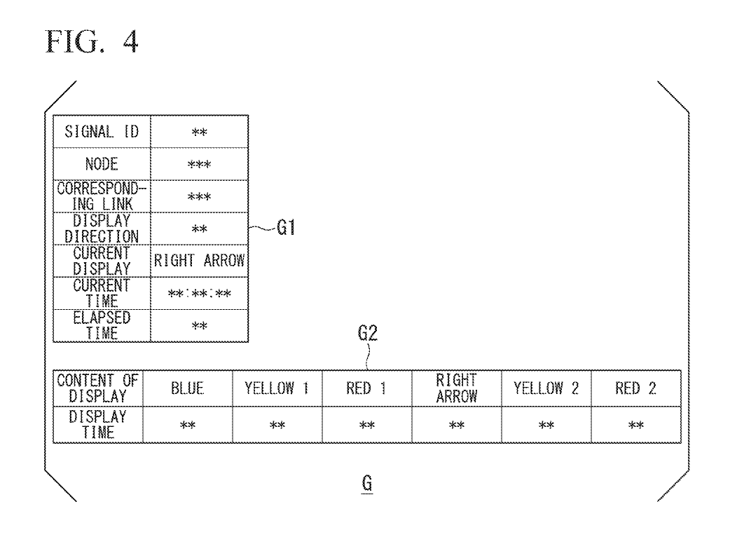

The signal information acquisition unit 134 may access the network via the communication device 20 and acquire the management information of the signal S from a server that manages a traffic state. FIG. 4 is a diagram showing an example of the content of the management information G of the signal S. The management information G includes, for example, information G1 in which an ID of the signal, a node of the road on which the signal is installed, a link corresponding to the road managed by the signal, a current display, a current time, an elapsed time from a start of display of content of a display that is being displayed, and the like are associated with each other, and information G2 in which content of a display of one cycle of the signal S and a display time of content of each display are associated with each other.

The signal information acquisition unit 134, for example, recognizes the traffic management state of the signal at the time of acquisition of the management information G by referring to the acquired management information G. The signal information acquisition unit 134 may predict the traffic management state of the signal S at a future point in time with reference to an elapsed time of the content of the current display and a current time on the basis of the management information G. The signal information acquisition unit 134 calculates a remaining time of the display currently displayed on the signal S by referring to the acquired management information G, and predicts a timing at which the current display will be switched in the future. The signal information acquisition unit 134 predicts a future traffic management state on the basis of the predicted timing and the information G2.

In a case that the management information G cannot be acquired, the signal information acquisition unit 134 may recognize the current traffic management state of the signal on the basis of a recognition result recognized by the camera 10, and predict a timing at which the current display will be switched in the future.

The signal information acquisition unit 134 may store the traffic management state of the signal recognized during traveling in the past in a storage unit (not shown), and recognize a display pattern of the signal on the basis of data of the stored past signal management state through learning.

The signal information acquisition unit 134 may calculate a remaining time of the display currently displayed on the signal S on the basis of the current traffic management state of the signal recognized by the camera 10 and the learned display pattern of the signal, and predict a timing at which the current display will be switched in the future. The signal information acquisition unit 134 outputs the recognition and prediction results to the route selection unit 142.

[Function of Route Selection Unit]

The route selection unit 142 determines a route on the basis of a surrounding situation of the subject vehicle M recognized by the surrounding environment recognition unit 132 and the signal information acquisition unit 134 and controls acceleration/deceleration and steering of the subject vehicle M. The route selection unit 142 causes the subject vehicle M to travel according to the determined route.

In a case in which a route along which the subject vehicle M can arrive at the destination can be set (in a range of a prescribed cost) even in a case that the subject vehicle M progresses in any of progression directions selected at a position of the signal 51, the route selection unit 142 determines a route to the destination on the basis of a result of recognition or prediction of the signal information acquisition unit 134. “In a range of prescribed cost” means that as compared with a progression route in one progression direction, a progression route in another progression direction is within a predetermined time (within a predetermined distance).

In a case that a route along which the subject vehicle M can arrive at a destination can be set even though the subject vehicle M progresses in any of progression directions that can be selected at the intersection at which the signal is provided, the route selection unit 142 determines an efficient route to the destination on the basis of information acquired by the signal information acquisition unit 134 and then causes the subject vehicle M to travel along the route.

Referring back to FIG. 3, the route selection unit 142, for example, compares the route A with the route B to determine whether or not a difference between a distance D1 of the route A and a distance D2 of the route B is in a predetermined range. In a case that a positive determination is obtained, the route selection unit 142 adds the route B as a route that is a selection target. The predetermined range may be, for example, a predetermined range such as −1 [km] to 1 [km] or may be a range determined according to a length of a distance from a current place to the destination. The route selection unit 142, for example, sets candidates of a plurality of routes at a point in time in a case that the destination is set. The route selection unit 142 may appropriately generate a route that is another selection target at a point (for example, in front of a node) of the road which is passed through.

The route selection unit 142 may determine the route that is a selection target using time instead of (or in addition to) using the predetermined range. The route selection unit 142, for example, may calculate a time required to reach a destination on each route. The route selection unit 142, for example, may compare a required time T1 to reach the destination of the route A with a required time T2 to reach the destination of the route B in a state in which the route A is selected, determine whether or not a difference between the longer required time and the shorter required time is within a predetermined time, and add the route B as the route that is a selection target in a case that the difference is within the predetermined time.

The predetermined time may be, for example, a predetermined value that is determined in advance or may be a value that is determined according to a length of a distance from a current place to the destination or a length of a required time. The required time, for example, may be updated at any time on the basis of the distance and a current average speed of subject vehicle M. The required time can be changed due to an influence of a traffic situation such as congestion, roadwork, accidents, and traffic restrictions.

Information indicating that traffic regulations have occurred on the route A is acquired in a state in which the route A is selected, and in a case that updating to a long required time is performed, the route selection unit 142 may select the route B in a case in which a difference between the required time T1 to the destination in the route A and the required time T2 to the destination on the route B exceeds a predetermined time. The route selection unit 142 may perform overall evaluation by scoring both the route based on the distance and the route based on the time in setting the route.

Next, a process that is executed by the route selection unit 142 at the intersection will be described. In principle, the route selection unit 142 gives priority to traveling straight as compared with turning right at the intersection and sets the route. This is because, for turning right, a waiting time is highly likely to occur and it takes a passing time as compared with traveling straight. This is because the degree of difficulty of control in turning right is higher than that in traveling straight even in a case that automated driving is performed.

In a case that the traffic management state of the signal at the time of acquisition of the management information G is a state in which the subject vehicle M can travel straight ahead (for example, the display color of the signal is blue), the route selection unit 142 gives priority to causing the subject vehicle M to progress straight and determines the route. However, in a case that the traffic control state of the signal is a state in which the subject vehicle M cannot travel straight ahead and can progress in either one of directions of turning right and turning left (for example, an arrow display corresponding to the right or left progression direction), the route selection unit 142 gives priority to causing the vehicle to progress in either one of directions of turning right and turning left and determines the route.

For example, in a case that there is the route A along which the subject vehicle M travels straight at the intersection P1 and the route B along which the subject vehicle M turns to right, and a route along which the subject vehicle M can arrive at a destination even though the subject vehicle M progresses along any of the route A and the route B can be set, the route selection unit 142 causes the subject vehicle M to travel on a road in a direction in which the subject vehicle M can progress, which corresponds to the content of a display displayed by the signal S1.

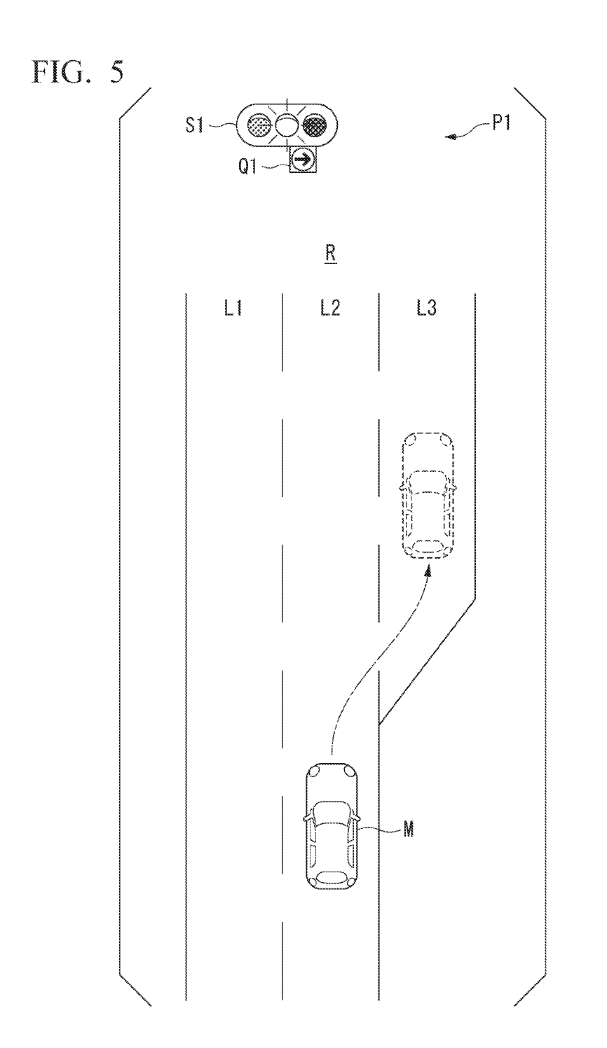

FIG. 5 is a diagram showing an intersection at which the subject vehicle M turns right. In a case that a route that the subject vehicle M can arrive at a destination can be set even in a case that the subject vehicle M progresses in any of progression directions that can be selected at the intersection P1 before the subject vehicle M passes through the intersection P1 at which the signal is provided, the route selection unit 142 selects a lane in which the number of times of lane change according to the content of the display of the signal is reduced among a plurality of lanes. In a case that the subject vehicle M travels in the lane L1, the subject vehicle M needs to move from the lane L1 to the lane L2 in order to change the lane to the lane L3 and then move from the lane L2 to the lane L3. Accordingly, it is necessary to perform the lane change twice.

In a case that there are a plurality of lanes L1 and L2 adjacent to a right turn lane (lane L3), the route selection unit 142 causes the subject vehicle M to travel on the lane L2 on which it is easy for change lanes to the right turn lane to be performed in advance before the subject vehicle M arrives at the right turn lane. In a case that the right turn lane is provided on the road R, the route selection unit 142 causes the subject vehicle M to perform a lane change to the right turn lane and then causes the subject vehicle M to turn right.

In a case that the subject vehicle M travels in the lane L2, the subject vehicle M can travel straight ahead at the intersection P1, and the number of times of lane change to the right turn lane becomes one. In a case that the subject vehicle M travels in the lane L2, the number of times of lane change to the lane L1 is one even in a case that it is necessary for the subject vehicle M to turn left. The route selection unit 142, for example, causes the subject vehicle M to travel in the lane L2 adjacent to the right turn lane at a position at a predetermined distance or more in front of the intersection at which the subject vehicle M can turn right.

The predetermined distance is a movement distance of the subject vehicle M in an extending direction of the road, which is required for change of the lane to the right turn lane. The predetermined distance is, for example, a predetermined fixed value. The predetermined distance may be set to be longer according to an increase in a speed of the subject vehicle M. By performing such a process, even in a case that a route in which the subject vehicle M turns right at the intersection on the basis of the recognition result of the signal is set, it is possible to reduce the number of times of lane change to the right turn lane.

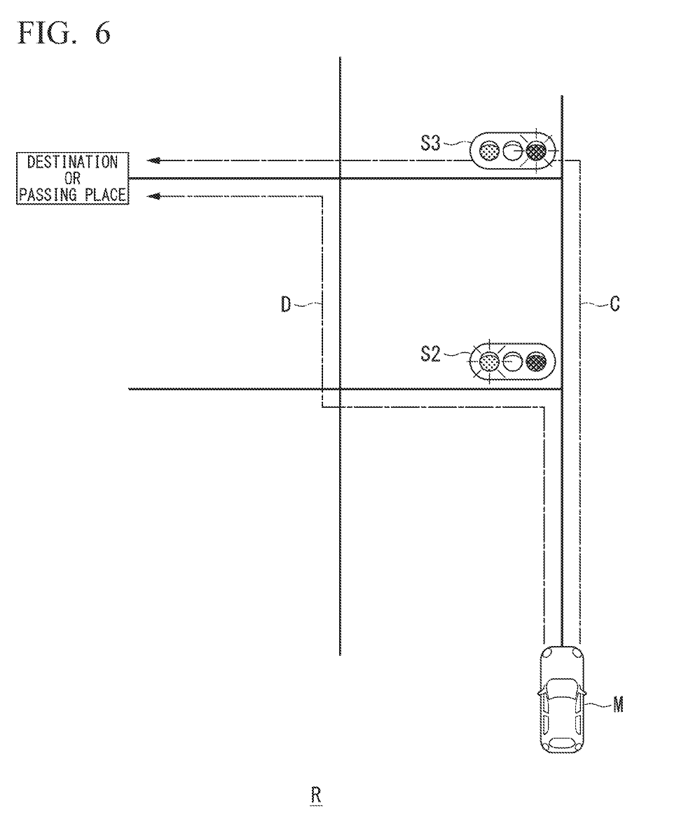

FIG. 6 is a diagram showing another example of roads on which signals are provided. The route selection unit 142 changes a route to a destination according to the number of signals on the route to the destination. In the example of FIG. 6, in a route C, a signal S2 and a signal S3 are provided on the route to the destination. In a route D, the signal S2 is provided on the route to the destination.

The route selection unit 142 calculates the number of signals in the route to the destination (or a passing place) in association with the position by referring to information on the signal on the road R acquired from the signal information acquisition unit 134. The route selection unit 142 performs change to a route on which the number of signals is small among routes that can be selected to the destination.

In a case that the route D of which the distance to the destination is substantially the same as that of the route C can be selected in a state in which the route C is planned, the route selection unit 142 compares the number of signals in the route C with the number of signals in the route D. The route selection unit 142 sets the route D having a small number of signals as a route on the basis of a result of the comparison. The route selection unit 142 causes the subject vehicle M travel according to the route D.

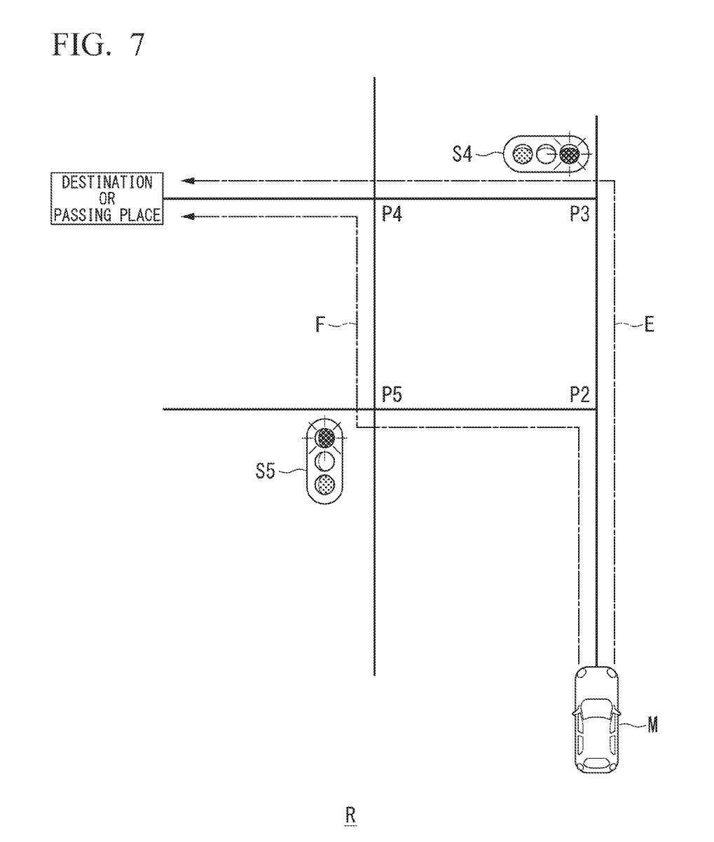

FIG. 7 is a diagram showing another example of roads on which signals are provided. In the example of FIG. 7, a route E and a route F having substantially the same distances to a destination are provided. The number of signals is the same in the route E and the route F. The route selection unit 142 may determine the route to the destination on the basis of the switching time of the traffic management state of the signal, on the basis of the recognition or prediction of the signal information acquisition unit 134.

For the switching time of the traffic management state of the signal, for example, a display time of a red light of the signal is used as a reference. The route selection unit 142, for example, sets a route for avoiding an intersection at which a signal with a long display time of the red light is provided. In a case that the route selection unit 142 sets any of the route E and the route F, the route selection unit 142 determines a route to the destination on the basis of the display time of the red light of the signal of each route.

The route selection unit 142, for example, compares the display times of the red lights of the signals S4 and S5 in the routes E and F that can be selected up to the destination by referring to the management information G of the signals S4 and S5 on the road R. The route selection unit 142 sets a route having a shorter display time of the red light of the signal from among the routes that are comparison targets.

The route selection unit 142 may use a remaining time of the display currently displayed by the signal as the reference, as a reference of a switching time of the traffic management state of the signal. The route selection unit 142, for example, calculates a remaining time of a display displayed by a signal S4 at an intersection P4 through which the vehicle is going to pass in the route E with reference to the management information.

The route selection unit 142 predicts content of a future display of the signal S4 on the basis of the calculated remaining time. The route selection unit 142 calculates an arrival time in a case that the vehicle arrives at the intersection P3 in a case in which the vehicle travels on the route E. The route selection unit 142 predicts the content of the displays of the signal S4 at the arrival time.

The standby time is a remaining time of a display regarding the stop in a case that the signal is displaying the display regarding the stop in a direction in which the subject vehicle travels, such as a red light, at a future point in time in a case that the subject vehicle M arrives at the intersection P3 or P5. The display regarding the stop is an arrow display in a direction other than a progression direction in which the subject vehicle M is scheduled to travel, such as the red light. The standby time is calculated by referring to the management information G.

Through the same process, the route selection unit 142 predicts content of a future display of a signal S5 on the route F, and calculates a required time from a current place to a destination or a passing place in a case that the vehicle travels along the route F, including a standby time according the signal S5. The route selection unit 142 compares the required times of the route E and the route F with each other and sets a route having a shorter required time.

The route selection unit 142 may use a time of one cycle in which the content of the display of the signal circulates, as a reference for a switching time of the traffic management state of the signal. The route selection unit 142, for example, sets a route for avoiding an intersection at which a signal with a long switching period of the traffic management state is provided. In a case that the route selection unit 142 sets any of the route E and the route F, the route selection unit 142 determines a route to the destination on the basis of the switching time of the traffic management state of the signal of each route.

The route selection unit 142, for example, refers to the management information G of the signals S4 and S5 on the road R, and compares the switching periods of the traffic management states of the signals S4 and S5 with each other in the routes E and F that can be selected to the destination. The route selection unit 142 sets a route having a shorter switching period of the traffic management state of each signal among routes that are comparison targets. This is because in the route having a shorter switching period of the traffic management state of the signal, the signal is immediately switched to a green light even in a case that the signal is a red light, and the required time is highly likely to be shortened.

A trigger for applying each of the determinations includes a situation in which “passage of an intersection cannot be made in time while the signal is displaying blue”. In a case that such a situation occurs, the route selection unit 142 performs a determination on the following premise. For example, in a case that the subject vehicle M is traveling in front of the intersection, the traffic management state of the signal may be changed from a display indicating that the subject vehicle M can travel straight ahead (blue display, an arrow display indicating a straight traveling direction, or the like) to a display other than the display indicating that the subject vehicle M can travel straight ahead (an arrow display of right turn or the like). Hereinafter, a process of the route selection unit 142 in a case that the display of the signal is changed will be described.

The route selection unit 142, for example, calculates a distance between the subject vehicle M and the intersection P1 on the basis of information on the current position of the subject vehicle M and the road acquired from the navigation device 50 and the information on the position of the intersection P1 acquired from the second map information 62. The route selection unit 142 calculates a first time T until the subject vehicle M arrives at the position of the intersection P1 from the current position on the basis of the calculated distance and the speed of the subject vehicle M.

Next, the route selection unit 142, for example, refers to the remaining display time for which the signal S1 displays a display indicating that the subject vehicle M can travel straight ahead, on the basis of a result of prediction of the signal information acquisition unit 134. The route selection unit 142 compares the calculated first time T with the remaining display time for which the signal 51 displays a display indicating that the subject vehicle M can travel straight ahead. In a case that the first time T is shorter than the remaining display time for which the signal 51 displays a display indicating that the subject vehicle M can travel straight ahead, the route selection unit 142 determines that the subject vehicle M can travel straight ahead at the intersection P1 while the signal 51 displays the display indicating that the subject vehicle M can travel straight ahead. In a case that the route selection unit 142 determines that the subject vehicle M can travel straight ahead at the intersection P1, the route selection unit 142 selects the route A, sets a route along which the subject vehicle M is caused to travel straight ahead at the intersection P1 and causes the subject vehicle M to travel.

The route selection unit 142 compares the calculated first time T with the remaining display time of the signal S1. In a case that the first time T is equal to or longer than the remaining display time for which the signal S1 displays a display indicating that the subject vehicle M can travel straight ahead, the route selection unit 142 determines that the subject vehicle M cannot travel straight ahead at the intersection P1 while the signal S1 displays the display indicating that the subject vehicle M can travel straight ahead.

In a case that the route selection unit 142 determines that the subject vehicle M cannot travel straight ahead at the intersection P1, the route selection unit 142 determines whether or not the subject vehicle M can progress in the right turn direction at the intersection P1 within the display time of the arrow display Q1 after the content of the display of the signal S1 is switched to the arrow display Q1 (for example, the right turn direction) on the basis of a prediction result acquired from the signal information acquisition unit 134.

The route selection unit 142 compares the remaining display time of the arrow display Q1 acquired from the signal information acquisition unit 134 with the first time T. The signal information acquisition unit 134 acquires the remaining display time of the arrow display Q1 on the basis of an output result of the signal information acquisition unit 134. In a case that the display of the arrow display Q1 is started, the route selection unit 142 calculates the remaining display time of the arrow display Q1 on the basis of the display time of the arrow display Q1 and the elapsed time from the display start of the arrow display Q1.

In a case that a display of the arrow display Q1 has not yet been started, the signal information acquisition unit 134 adds a remaining time of content of a current display, a display time of a yellow display with reference to a current time, and a display time of the arrow display Q1 on the basis of the elapsed time of the content of the current display to calculate a remaining display time of the arrow display Q1.

In a case that the first time T is shorter than the remaining display time of the arrow display Q1, the route selection unit 142 determines that the subject vehicle M can turn right at the intersection P1 while the signal S 1 displays the arrow display Q1. In a case that the first time T is equal to or longer than the remaining display time of the arrow display Q1, the route selection unit 142 determines that the subject vehicle M cannot turn right at the intersection P1 while the signal S 1 displays the arrow display Q1.

In a case that it is determined that the subject vehicle M cannot turn right at the intersection P1 while the signal 51 is displaying the arrow display Q1, the route selection unit 142 decelerates or stops the subject vehicle M according to the display of the signal S1. In a case that it is determined that the subject vehicle M can turn right at the intersection P1, the route selection unit 142 sets the route B and causes the subject vehicle M to turn right at the intersection P1.

In a case in which the lane change is performed, for example, in a case that the subject vehicle M turns right, the route selection unit 142 sets a lane in which the subject vehicle M is caused to travel so that the number of times of lane change is reduced.

[Flow of Process]

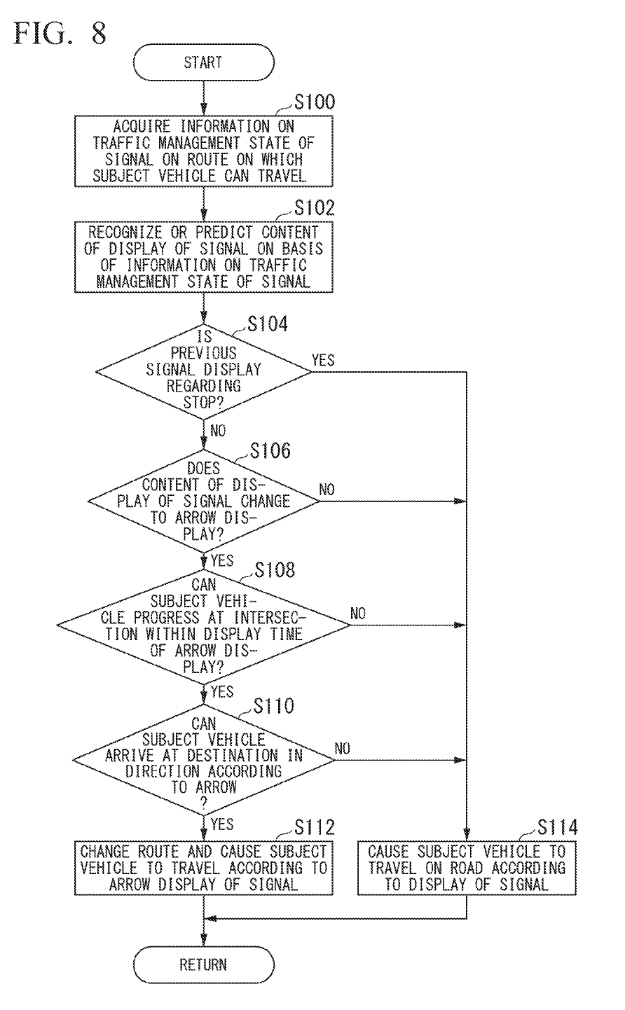

Next, a process that is executed in the automated driving control device 100 will be described. FIG. 8 is a flowchart showing an example of a short-term flow of a process that is executed in the automated driving control device 100. In this flow, it is assumed that a destination is set and a plurality of routes to a destination that can be selected at a point which is passed through are generated. The following process is executed on the basis of information acquired while the vehicle is traveling.

The signal information acquisition unit 134 acquires information on the traffic management state of the signal on the route on which the subject vehicle travels or around the route (step S100). Then, the signal information acquisition unit 134 recognizes or predicts the content of the display of the signal on the basis of the acquired information on the traffic management state of the signal (step S102).

The signal information acquisition unit 134 determines whether or not the signal provided at the intersection displays a display regarding stop (step S104).

In a case that a negative determination is obtained in step S104, the route selection unit 142 determines whether or not the content of the display of the signal changes to an arrow display before the subject vehicle arrives at the intersection on the basis of a prediction result of the content of the display of the signal predicted by the signal information acquisition unit 134 (step S106). Then, in a case that a positive determination is obtained in step S106, the route selection unit 142 determines whether the subject vehicle can progress in a right turn direction at the intersection within the display time of the arrow display displayed by the signal (step S108).

In a case that a positive determination is obtained in step S108, the route selection unit 142 determines whether or not the subject vehicle can arrive at the destination by turning right at the intersection in a direction according to the arrow display of the signal (step S110). In a case that a positive determination is obtained in step S110, the route selection unit 142 gives priority to causing the subject vehicle to travel in the right turn direction, sets a route, and causes the subject vehicle to travel according to the arrow display of the signal (step S112).

In a case that a positive determination is obtained in step S104 and a negative determination is obtained in step S106, step S108, and step S110, the route selection unit 142 causes the subject vehicle to travel according to the display of the signal (step S114). After steps S112 and S114, the route selection unit 142 ends the process of the flowchart and starts the process of a new flowchart. In the flowchart described above, the order of the respective steps is not limited thereto and may be replaced appropriately or each step may be omitted appropriately.

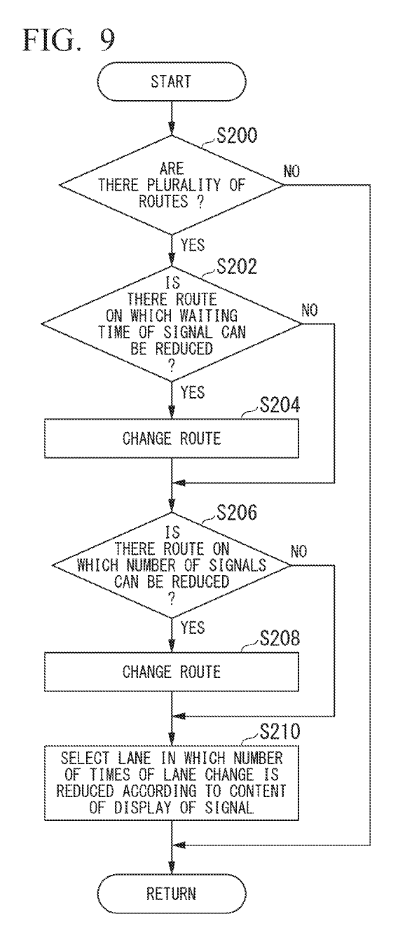

Next, a process of determining a long-term route that is executed in the automated driving control device 100 in a case that a destination is set will be described. FIG. 9 is a flowchart showing an example of a flow of a process of determining a long-term route that is executed in the automated driving control device 100.

The route selection unit 142 determines whether or not a plurality of routes can be selected as routes to the destination (step S200). In a case that a positive determination is obtained, the route selection unit 142 determines whether or not another route on which a waiting time of the signal can be reduced can be selected (step S202).

In a case that a positive determination is obtained in step S202, the route selection unit 142 sets another route on which a waiting time of the signal can be reduced and causes the subject vehicle to travel (step S204). In a case that a negative determination is obtained in step 202, the route selection unit 142 causes the process to proceed to step S206.

Then, the route selection unit 142 determines whether or not another route on which the number of signals can be reduced can be selected (step S206). In a case that a positive determination is obtained in step S206, the route selection unit 142 sets another route on which the number of signals can be reduced and causes the subject vehicle to travel (step S208). In step S210, the route selection unit 142 sets a lane in which the number of times of lane change is reduced according to the content of the display of the signal in a road in front of a point at which the signal is provided in the route.

In a case that a negative determination is obtained in step 5200 and after the process of step 5210 is performed, the route selection unit 142 ends the process of the flowchart and starts the process of a new flowchart. In the flowchart described above, the order of the steps is not limited thereto and may be replaced appropriately. Each step may be omitted appropriately.

According to the embodiment described above, the automated driving control device 100 can determine an efficient route to the destination in consideration of the presence of signals. The automated driving control device 100 can reduce a required time to the destination by performing change to a route according to the content of the display of the signal, the number of signals, and the display time to the destination.

### <Hardware Configuration>

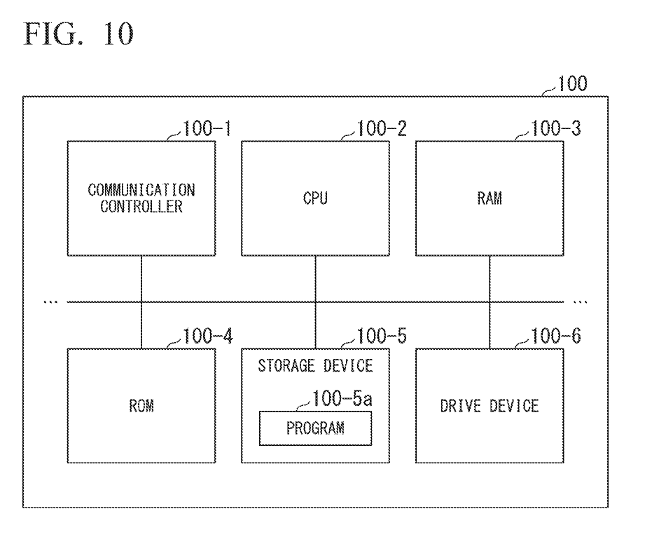

FIG. 10 is a diagram showing an example of a hardware configuration of the automated driving control device 100 according to the embodiment. As shown in FIG. 10, the automated driving control device 100 has a configuration in which a communication controller 100-1, a CPU 100-2, a random access memory (RAM) 100-3 that is used as a work memory, a read only memory (ROM) 100-4 that stores a boot program or the like, a storage device 100-5 such as a flash memory or a hard disc drive (HDD), a drive device 100-6, and the like are connected to each other by an internal bus or a dedicated communication line. The communication controller 100-1 communicates with components other than the automated driving control device 100. A program 100-5a to be executed by the CPU 100-2 is stored in the storage device 100-5. This program is developed in the RAM 100-3 by a direct memory access (DMA) controller (not shown) or the like and executed by the CPU 100-2. Accordingly, some or all of the surrounding environment recognition unit, the signal information acquisition unit, and the route selection unit are realized.

The above-described embodiment can be represented as follows.

A vehicle control device including

a storage device that stores a program, and

a hardware processor,

wherein the hardware processor is configured to

acquire information on a traffic management state of a signal on a route of a vehicle,

recognize a situation of surroundings of the vehicle,

control acceleration, deceleration, and steering of the vehicle on the basis of the recognized situation of the surroundings of the vehicle, and

determine a route to the destination on the basis of the acquired information and cause the vehicle to travel in a case that a route along which the vehicle is able to arrive at the destination is able to be set irrespective of which of directions of progression of the vehicle is selected at an intersection at which a signal is provided, by executing the program stored in the storage device.

Although modes for carrying out the present invention have been described above using the embodiments, the present invention is not limited to these embodiments at all, and various modifications and substitutions may be made without departing from the scope of the present invention. For example, although the process of route selection with respect to the arrow display of right turn of the signal has been shown in the above-described embodiments, the above process may be applied to route selection with respect to the arrow display in another direction such as left turn and straight traveling of the signal.

What is claimed is:

1. A vehicle control device comprising:
a recognition unit including an acquisition unit that is configured to acquire information on a traffic management state of signals on a route of a vehicle, the recognition unit recognizing a situation of the surroundings of the vehicle; and
a driving control unit that is configured to control acceleration, deceleration, and steering of the vehicle on the basis of the situation of the surroundings of the vehicle recognized by the recognition unit,
wherein in a case that a route along which the vehicle is able to arrive at a destination is able to be set irrespective of which of directions of progression of the vehicle is selected at an intersection at which a signal is provided, the driving control unit is configured to determine a route to the destination on the basis of information acquired by the acquisition unit to cause the vehicle to travel.

2. The vehicle control device according to claim 1,
wherein the acquisition unit is configured to recognize the traffic management state of the signal at a point in time of acquisition of the information and/or predict the traffic management state of the signal at a future point in time.

3. The vehicle control device according to claim 2,
wherein the driving control unit is configured to give priority to causing the vehicle to progress straight to set the route in a case that the traffic management state of the signal at the time of acquisition of the information is a state in which the vehicle is able to travel straight ahead, and is configured to give priority to causing the vehicle to progress in either one of directions of turning right and turning left to set the route in a case that the traffic control state of the signal is a state in which the vehicle is unable to travel straight ahead and able to progress in either one of directions of turning right and turning left.

4. The vehicle control device according to claim 1,
wherein the driving control unit is configured to compare the routes to the destination that are able to be selected with each other, and determine the route to the destination according to the traffic management state of the signal in a case that a difference between required times to the destination is within a predetermined time, or in a case that a difference between distances to the destination is within a predetermined range.

5. The vehicle control device according to claim 1,
wherein the driving control unit is configured to determine the route to the destination on the basis of a switching time of the traffic control state of the signal.

6. The vehicle control device according to claim 1,
wherein the driving control unit is configured to compare the routes to the destination that are able to be selected with each other on the basis of the information acquired by the acquisition unit, and set the route to the destination so that the number of signals before the destination is reduced.

7. The vehicle control device according to claim 1,
wherein the driving control unit is configured to set a route to the destination in which the vehicle progresses in a direction of an arrow display in a case that the driving control unit determine that the vehicle is able to progress to a road corresponding to the arrow display within the display time of the arrow display displayed by the signal.

8. The vehicle control device according to claim 1,
wherein the driving control unit is configured to select a lane in which the number of times of lane change is reduced according to a traffic management state of the signal among a plurality of lanes provided in the progression direction of the vehicle before the vehicle passes through an intersection corresponding to the signal.

9. A vehicle control method using an in-vehicle computer, comprising:
acquiring, by a vehicle control device, information on a traffic management state of a signal on a route of a vehicle;
recognizing, by the vehicle control device, a situation of surroundings of the vehicle;
controlling, by the vehicle control device, acceleration, deceleration, and steering of the vehicle on the basis of the recognized situation of the surroundings of the vehicle; and
determining, by the vehicle control device, a route to the destination on the basis of the acquired information and causing the vehicle to travel in a case that a route along which the vehicle is able to arrive at the destination is able to be set irrespective of which of directions of progression of the vehicle is selected at an intersection at which a signal is provided.

10. A computer-readable non-transient storage medium storing a program, the program being configured to cause a vehicle control device to:
acquire information on a traffic management state of a signal on a route of a vehicle;
recognize a situation of surroundings of the vehicle;
control acceleration, deceleration, and steering of the vehicle on the basis of the recognized situation of the surroundings of the vehicle; and
determine a route to the destination on the basis of the acquired information and cause the vehicle to travel in a case that a route along which the vehicle is able to arrive at the destination is able to be set irrespective of which of directions of progression of the vehicle is selected at an intersection at which a signal is provided.
